(19) United States
(12) Patent Application Publication
(10) Pub. No.: US 2013/0257302 A1
(43) Pub. Date: Oct. 3, 2013

(54) DIMMER COMPATIABLE LED BULB DRIVER CIRCUIT

(71) Applicants: Stanley Canter, Hermosa Beach, CA (US); John Grainger, Fremont, CA (US)

(72) Inventors: Stanley Canter, Hermosa Beach, CA (US); John Grainger, Fremont, CA (US)

(73) Assignee: Switch Bulb Company, Inc., San Jose, CA (US)

(21) Appl. No.: 13/433,164

(22) Filed: Mar. 28, 2012

(51) Int. Cl. H05B 37/02

(52) U.S. Cl. 315/200 R

(57) ABSTRACT

A light-emitting diode (LED) bulb for use with a leading-edge dimmer includes a shell and an LED contained within the shell. A base is attached to the bulb for connecting the LED bulb to an electrical socket. A driver circuit is configured to provide current to the LED. The driver circuit has an input filter circuit that includes a first inductor. In response to the input filter receiving a switched AC voltage from a leading-edge dimmer set to dim at 50%, the first inductor is configured to saturate. In response to an undimmed AC voltage from the leading-edge dimmer, the first inductor is configured to not saturate. The input filter also includes a bridge rectifier connected to the first inductor.

### BACKGROUND

1. Field

The present disclosure generally relates to a light emitting diode (LED) driver circuit for use with LED bulbs, and more particularly, to an improved input filter for the LED driver circuit for use with TRIAC-based leading-edge dimmers.

2. Description of the Related Art

LED bulbs are becoming increasingly more popular for lighting applications. One barrier to LED bulbs' widespread adoption in residential applications is the widespread presence of light dimmers. For proper operation, the LEDs in an LED bulb require power from LED drivers that supply a constant, controlled current. These LED drivers must be specially designed if the LED bulb is to properly work with many types of dimmers commonly found in residential applications. These dimmers are designed to work with incandescent bulbs that electrically operate differently than LED bulbs.

Some LED bulbs include components that cause the LED bulb to act more like an incandescent bulb. However, the addition of these components can take up space, cost more, and reduce the efficiency of the LED bulb.

Alternatively, instead of properly designing the LED bulb to work with residential dimmers, some LED bulbs are sold with labels warning that the LED bulbs are not to be used with a dimmer. However, this option is not useful for areas where regulatory bodies require compatability with dimmers or where consumers desire to use dimmers.

Another barrier to the widespread adoption of LED bulbs is that in addition to requiring a specially designed LED driver that works with dimmers, the LED driver, the LEDs, a heat sink, and other components must all fit within the standard enclosure for common residential incandescent light bulbs. The form factor of the bulb limits the size, type, and number of the components that may be used.

Therefore, there is a need for a LED bulb that works with common residential light dimmers and that fits all the necessary components within standard incandescent light bulb form factors.

### SUMMARY

One embodiment of a light-emitting diode (LED) bulb for use with a leading-edge dimmer includes a shell and an LED contained within the shell. A base is attached to the bulb for connecting the LED bulb to an electrical socket. A driver circuit is configured to provide current to the LED. The driver circuit has an input filter circuit that includes a first inductor. In response to the input filter receiving a switched AC voltage from a leading-edge dimmer set to dim at 50%, the first inductor is configured to saturate. In response to an undimmed AC voltage from the leading-edge dimmer, the first inductor is configured to not saturate. The input filter also includes a bridge rectifier connected to the first inductor.

### DESCRIPTION OF THE FIGURES

FIG. 1 depicts the effects of using saturating inductors in an exemplary embodiment of a LED driver circuit.

FIG. 2 depicts the output wave forms associated with common residential light dimmers.

FIG. 3 depicts a block level schematic of an exemplary driver circuit.

FIGS. 4A and 4B depict a component level schematic of the exemplary driver circuit.

FIG. 5 depicts the input current waveform for the exemplary embodiment.

FIG. 6 depicts an alternative exemplary embodiment of an LED bulb driver circuit.

FIG. 7 depicts an exemplary LED bulb that uses a driver circuit with saturating inductors.

FIG. 8 depicts an A19 bulb and E26 connector found in a common light bulb form factor.

FIG. 9A depicts the input to an input filter of an LED bulb driver circuit.

FIG. 9B depicts the output from an input filter of an LED bulb driver circuit with energy storage.

FIG. 9C depicts the output from an input filter of an LED bulb driver circuit with zero energy storage.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### 1. Introduction

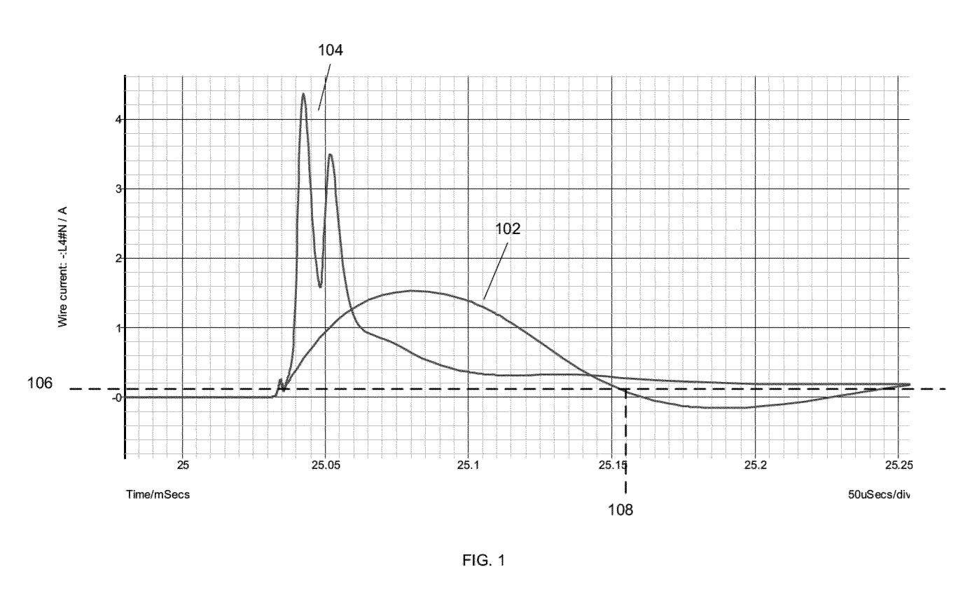

To ensure compatibility with common residential light dimmers, an exemplary embodiment of a LED driver circuit uses one or more saturating inductors to maintain current levels that allow proper operation of common types of residential light dimmers. To illustrate the effect of inductors that saturate in the exemplary embodiment, FIG. 1 depicts an LED bulb input current responses to a voltage step from a common type of leading-edge dimmer (the operation of this dimmer will be discussed further below). The two responses result from two different input filters in the LED driver circuit. Current waveform 102 illustrates the current resulting from an input filter employing large-value inductors that do not saturate. On the other hand, current waveform 104 illustrates the current resulting from the exemplary embodiment that employs an input filter with inductors that saturate. Current waveform 102 becomes negative and results in the problematic oscillations in TRIAC-based leading-edge dimmers, which are described in more detail below. In contrast, current waveform 104 is a result of saturation of the inductors within microseconds of the step voltage being applied to the LED bulb. The saturation of one or more inductors reduces or eliminates the negative swing in the current and preserves the proper operation of the TRAIC-based leading-edge dimmer. As such, inductor saturation characteristics are utilized to minimize dimmer switching effects.

### 2. Residential Light Dimmers

LED bulbs are often replacements for traditional incandescent bulbs used in residential applications, such as lamps or ceiling light fixtures. Many of these residential applications may make use of light dimmers that are designed to work with traditional incandescent bulbs. Thus, many consumers and some regulatory bodies may require that LED bulbs work with existing residential light dimmers.

There are many types of residential light dimmers. Some older designs were based on a variable resistor controlled by the user. With these dimmers, as the user increases the resistance, less voltage is applied to the light bulb and the light bulb output is dimmed. While these dimmers are very simple, they also suffer from being very inefficient. The light bulb dims because the variable resistor converts some of the power being provided at the dimmer into heat that is simply lost into the wall or air surrounding the dimmer. Thus, light dimmers of this type may get very hot and even be a fire hazard.

Modern light dimmers are typically much more efficient than the old variable resistor based dimmers. These dimmers use specialized electronics to block the AC voltage for some fraction of each full- or half-cycle of AC voltage. By blocking portions of the cycle, the dimmer reduces the power that reaches the light bulb, which reduces the light bulb output. Because the power is controlled by blocking portions of the AC voltage cycle, these dimmers are very efficient and do not suffer from the same heat issues as older variable resistor dimmers.

Two of the most common types of modern light dimmers are trailing-edge dimmers and leading-edge dimmers. Trailing-edge dimmers work by conducting an AC voltage some fraction of the cycle before blocking the voltage for the remainder of the cycle. The more of the cycle that is blocked, the dimmer the light. Alternatively, leading-edge dimmers work in the opposite manner. They start by blocking the AC voltage, but after some fraction of the cycle, they start conducting the AC voltage for the remainder of the cycle.

A common type of leading-edge dimmer is based on a TRIAC that is fired by a DIAC. The timing of the DIAC is controlled by a capacitor and a variable resistor, which determines when the DIAC causes the TRIAC to fire (i.e., the TRIAC firing angle). A TRIAC is a device that can conduct current in either direction between two terminals after being triggered or turned on by a current pulse at a third terminal. After being triggered, the TRIAC continues to conduct current between the first and second terminal until that current falls below some threshold value, which is called the holding current.

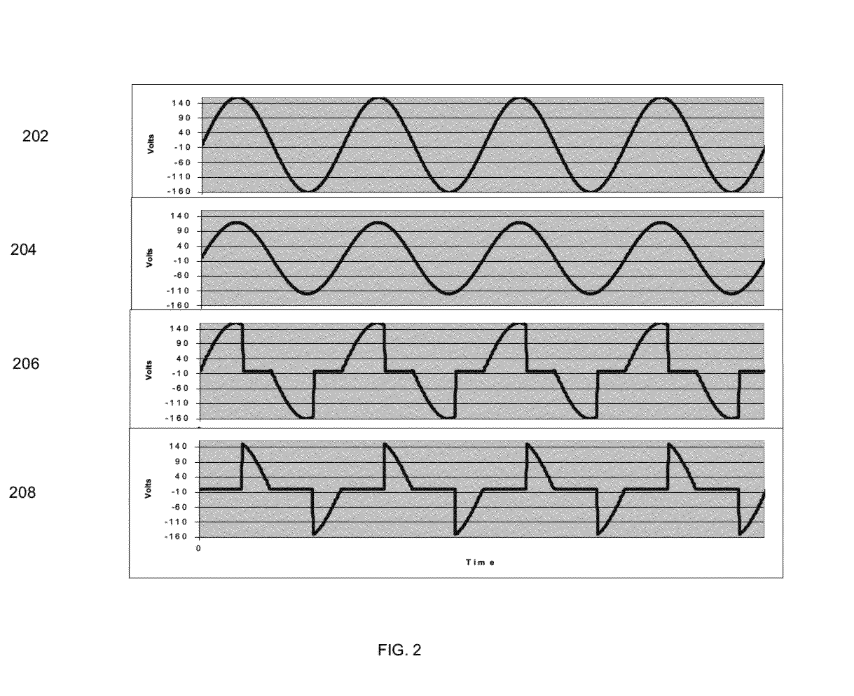

FIG. 2 shows an exemplary AC voltage waveform 202 that is the output of a common electrical socket found in a residential building. Waveform 204 is an exemplary output from an older variable resistor style dimmer when waveform 202 is used as an input. As can be seen, the shape of waveform 204 is similar to input waveform 202 except that the amplitude is attenuated by the variable resistor in the dimmer.

Waveform 206 is an exemplary waveform produced by using waveform 202 as an input to a trailing-edge light dimmer. As can be seen from waveform 206, after each half-cycle the voltage increases from zero and matches input waveform 202. However, after some amount of time, the waveform is cut off and remains cut off for the rest of the half-cycle. The process then continuously repeats itself for each new half-cycle.

Waveform 208 is an exemplary waveform produced by using waveform 202 as an input to a TRIAC-based leading-edge light dimmer. As can be seen from waveform 208, at the start of each half-cycle, the voltage is blocked by the dimmer because the TRIAC is off. After some amount of time, the DIAC fires the TRIAC, and the TRIAC starts conducting. When the TRIAC is fired, a step function in voltage occurs so that the output voltage of the dimmer matches the input waveform 202. Waveform 208 then mirrors input waveform 202 for the rest of the half-cycle. Once the input voltage returns to zero, the current through the TRIAC drops below the holding current and the TRIAC turns off. This process repeats itself continuously for each successive half-cycle.

In waveform 208, the firing angle is approximately 100 degrees with a conduction angle of 80 degrees. This results in a power output of approximately 45% of a normal power output.

As can be seen from waveforms 204 and 206, the outputs of the variable resistor and trailing-edge style dimmers do not produce outputs that include voltage steps that start with zero voltage and end with a non-zero voltage. In contrast, waveform 208 shows that the output from the leading-edge dimmer produces a voltage step from zero to a non-zero value. Unless the LED driver is properly designed, applying voltage steps like those present in waveform 208 to a LED bulb may cause unstable light output from the LED bulb.

For example, using the TRIAC-based leading-edge dimmer described above to supply waveform 208 to an LED bulb may cause the light output to flicker due to the response of the LED driver to the voltage step. The voltage step may cause ringing in filters or other components of the LED driver. If this ringing causes the current draw of the LED bulb to drop below the holding current of the TRIAC in the dimmer, then the TRIAC may turn off prematurely. However, the DIAC will immediately fire the TRIAC again and the process will continue, causing the light output of the LED bulb to flicker. Because the older variable resistor style and trailing-edge style dimmers do not produce similar voltage steps, the same problems do not occur with those styles of dimmers.

Referring again to FIG. 1, waveform 102 is the input current of the LED bulb in response to the voltage step caused by a TRIAC-based leading-edge dimmer. Waveform 102 is also the output current of the TRIAC-based leading-edge dimmer. If the TRIAC in the dimmer has a holding current 106, the TRIAC will turn off shortly after the input current of the LED light bulb drops below holding current 106 at time 108. The DIAC will then immediately turn the TRIAC back on. This process will continue through the rest of the half-cycle. This causes flicker in the light output of the LED. Furthermore, the repeated voltage steps may damage the LED bulb or the dimmer.

3. LED Drivers with Saturating Inductors

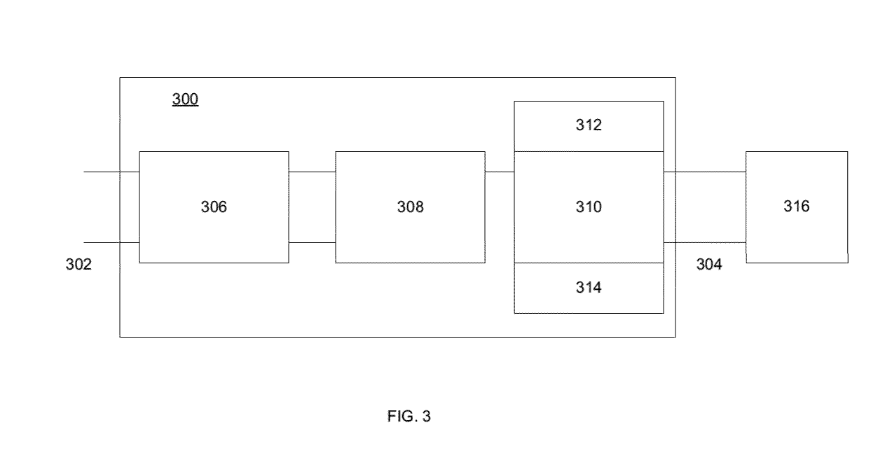

FIG. 3 depicts a functional level diagram of exemplary driver circuit 300 that is compatible with the standard residential dimmers described above. Driver circuit 300 may be used in an LED bulb to power one or more LEDs 316. Driver circuit 300 takes as input an input line voltage (e.g., 120 VAC, 60 Hz in the U.S.) or a line voltage from a residential dimmer at input 302 and outputs a current suitable for powering LEDs connected to output 304.

As will be described in more detail below, driver circuit 300 includes input protection circuit 306, input filter circuit 308, switched mode power supply (SMPS) circuit 310, thermal protection circuit 312, and power factor control circuit 314. Input protection circuit 106 is configured to protect driver circuit 300 and LEDs 316 from damage due to voltage spikes in the input line voltage or to prevent electrical shorts in the LED bulb from damaging the surrounding environment. Input protection circuit 306 is configured to also limit the input current when a switched voltage is first applied to input 302. Input filter circuit 308 is configured to maintain the a current draw above the holding current of a TRIAC based dimmer when supplied with a switched voltage. Input filter circuit 308 is also configured to condition the input line voltage for use with SMPS circuit 310, and to prevent noise generated by SMPS circuit 310 from reaching input 302 and affecting other devices connected to the input line voltage. SMPS circuit 310 is configured to convert the input line voltage to a current that is suitable for driving one or more LEDs 316. Thermal shutdown circuit 312 is configured to reduce or eliminate the current being supplied to LEDs 316 in the event that drive circuit 300, LEDs 316, or some other part of the LED bulb reaches a threshold temperature. Power factor control circuit 314 is configured to adjust the current that SMPS circuit 310 supplies to LEDs 316.

In one example, a driver circuit similar to driver circuit 300 may allow for light output from LEDs to be dimmed proportionally to the voltage available the SMPS circuit through the input filter circuit when the input is connected to a TRIAC-based dimmer. In this case, the voltage available to the SMPS circuit is proportional to the firing angle of the TRIAC-based dimmer.

It should be recognized that some of the circuits shown in FIG. 3 may be omitted. For example, if an LED bulb is operating in a cold or sufficiently ventilated area, then thermal protection circuit 312 may not be necessary. Alternatively, the input protection may take place outside of the LED bulb, and therefore, input protection circuit 106 may not be necessary.

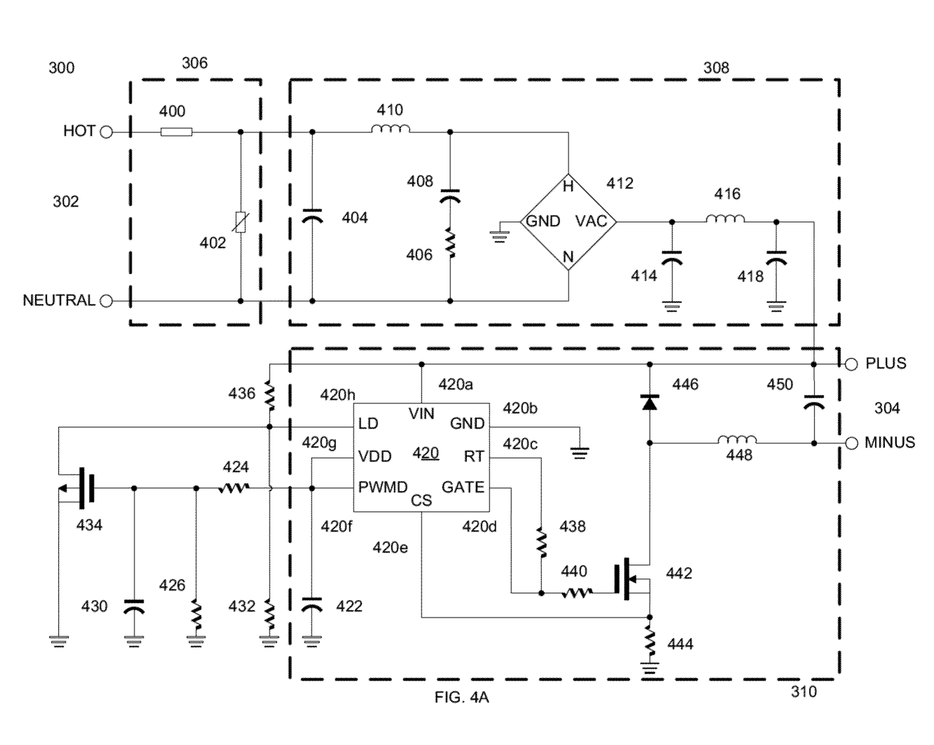

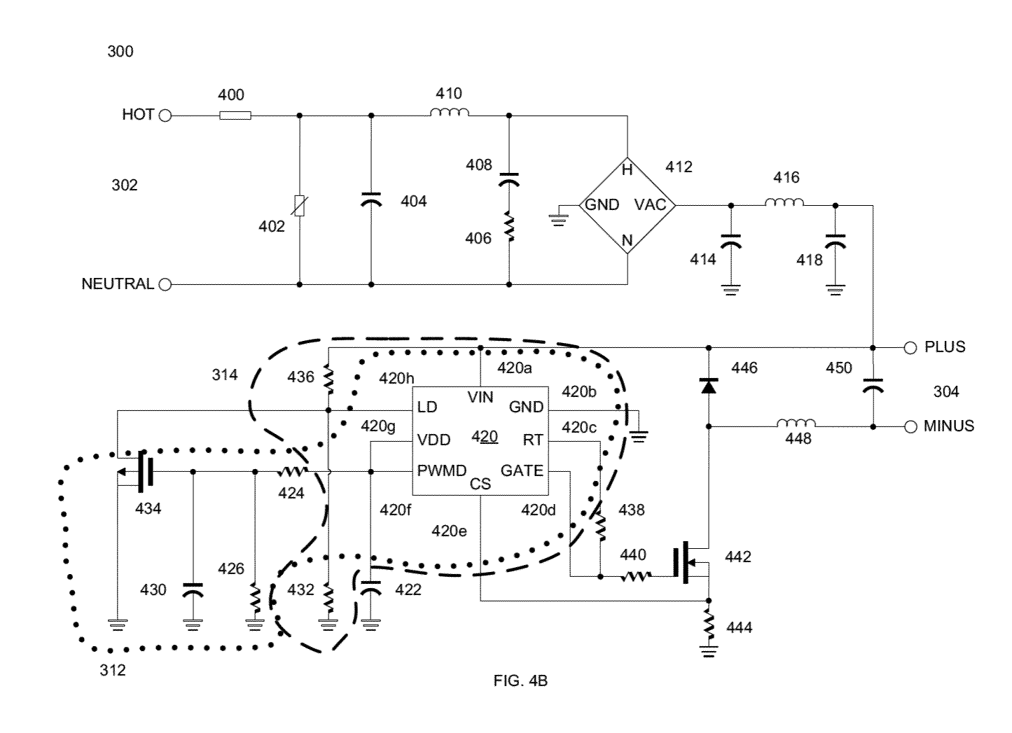

FIGS. 4A and 4B depict a component level schematic of driver circuit 100. The discussion below of the component level schematic lists several ranges, specific values, and part IDs for various components. It should be understood that these are not intended to be limiting. Other components values, parts, and ranges may also be used without deviating from a driver circuit using a thermal protection circuit as described herein. Additionally, while a specific circuit topology is presented in FIGS. 4A and 4B, a person skilled in the art will recognize that other topologies could be used without deviating from a driver circuit using a power factor control circuit as described herein.

Referring to FIG. 4A, input filter circuit 308 includes: capacitors 404, 410, 414, and 418; inductors 408 and 416; resistor 406; and bridge rectifier 412. As discussed below, inductors 408 and 416 are chosen so that driver circuit 300 is compatible with the standard residential dimmers discussed above. Inductors 408 and 416 may be 1-2 mH inductors or more specifically, about 200 turns of 36 gauge wires wound around a Magnetics CO58028A2 toroid core. This design for inductors 408 and 416 allows for one or both of the inductors to saturate in response to a switched input, which ensures the TRIAC holding current is maintained. Additionally, the relatively large inductance of inductor 408 and inductor 416 helps prevent noise from SMPS circuit 310 from affecting other devices connected to the input power supply.

Saturation is typically a limitation of inductors. Saturation of inductors is the state at which an increase in applied external magnetizing field (H) cannot increase the magnetization of the material further (or increases it by a smaller amount), resulting in the leveling off of the total magnetic field (B). Initially, the magnetic flux generated by an inductor increases proportional to an increasing current through an inductor. Saturation occurs when a change in current leads to a small or no change in magnetic flux.

In input circuit 308, when the current decreases, a forward voltage is generated based on the inductance value. In other words, a voltage is generated by inductor 408 in combination with inductor 416 to oppose a current below the holding current. A typical holding current is 30-40 mA. In this way, the voltage generated by inductor 408 and inductor 416 biases the TRIAC-based dimmer such that the holding current remains and the TRIAC continues to conduct.

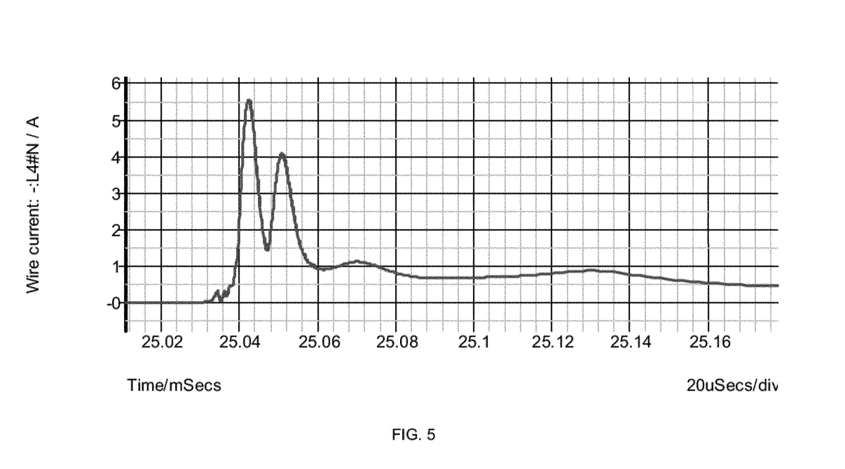

The current waveform generated by input filter 308 when inductor 408 or inductor 416 saturate is depicted in FIG. 5. The current remains positive and above the holding current. Therefore, the TRIAC-based dimmer remains on until the end of the half-cycle.

In addition to maintaining the LED bulb input voltage above the TRIAC holding current, the filters in the LED driver must also meet the requirements for electro-magnetic interference (EMI) test conditions. This means that to improve EMI performance, inductor 408 and inductor 416 may not saturate with a non-switched input with 150 mA RMS input current. Thus, in designing inductor 408 and inductor 416, one or both inductors must saturate in response to a 120 VAC switched input but may not saturate in response to 120 VAC non-switched input.

In one example of an input circuit according to the present invention, an inductor in the input circuit is selected so that it saturates even when receiving an input voltage from a TRIAC-based dimmer with lower or higher firing angles. For example, the inductor may saturate in response to an input voltage from a TRIAC based dimmer with a 45° or 135° firing angle.

The other components for input filter circuit 308 are selected to properly condition the input line voltage for use with SMPS circuit 310 and to prevent noise from SMPS circuit 310 from reaching input 302 and affecting other devices connected to the input line. The design of inductors 408 and 416 may also be important for suppressing noise from SMPS circuit 310.

In one example, if driver circuit 300 is connected to a 120 VAC, 60 Hz input line voltage, bridge rectifier 412 may be a 400V diode bridge rectifier. Capacitor 404 may be selected to suppress high frequencies generated by SMPS circuit 110 and may be 2.2 nF. The damping network of resistor 410 and capacitor 406 may help minimize ringing of driver circuit 300 when input 102 is connected to the input line voltage through a residential dimmer. Resistor 410 may be 120 Ω and capacitor 406 may be 680 nf. Filter capacitors 414 and 418 may be 100 nF.

Referring back to FIG. 4A, input protection circuit 306 includes fuse 400 that protects against short circuits in the rest of the driver circuit or LEDs and varistor 402 that protects against voltage spikes in the input line voltage. For example, fuse 400 may be a 250 mA slow blow micro fuse and varistor may be a 240V-rated metal oxide varistor.

SMPS circuit 310 includes: SMPS controller 420; switching element 442; resistors 438, 440, and 444; diode 446; inductor 448; and capacitor 450. SMPS controller 420 drives the switching speed and duty cycle of switching element 442, which controls the amount of current provided to the LEDs connected between output 304. Pins 420a-420h are input and output pins of SMS controller 420. In one example, SMPS controller 420 is implemented with an HV9910B controller made by Supertex Inc. If using the HV9910B IC or a similar controller, SMPS controller 420 may operate in either constant off-time or constant frequency mode.

In constant frequency mode (set by connecting resistor 438 between RT pin 420c and ground, the frequency of the output at GATE pin 420d is set by the value of resistor 438. The duty cycle of the output may then be set by resistor 444.

In constant off-time mode (set by connecting RT pin 420c to GATE pin 420d as shown in FIG. 4B), the duty cycle of the output at GATE pin 420d of SMPS controller 420 is set based on the value of resistor 438. The frequency of the output can then be varied with resistor 444, which is a current sense resistor that may cause the output at GATE pin 420d of SMPS controller 420 to reset to zero once a peak current has been reached through switching element 442, which is the same current as through the LEDs. As shown in FIGS. 4A and 4B, SMPS controller 420 is set for constant off-time mode because RT pin 420c is connected to GATE pin 420d through resistor 438.

The values for the other components in SMPS circuit 310 may be selected to provide suitable current to the LEDs connected to output 104, based on, among other factors, the input line voltage, the voltage drop across the LEDs, and the current required to drive the LEDs. For example, resistor 438 may be 300 kΩ, and resistor 440 may be 20 Ω. Capacitor 422 is a hold-up capacitor to maintain VDD during switching, and may be 1 uF. Switching element 442 may be selected to operate properly with the operating range of SMPS controller 420 and to provide sufficient current for the LEDs. Switching element 442 may be an IRFR320PBF HEXFET Power MOSFET from International Rectifier. Resistor 444 may be used to ensure that LEDs connected to output 304 are driven at the most efficient current level based on the required light output and may be 180 mΩ. Diode 446 provides a current path for the current stored in inductor 448 to be supplied to the LEDs when switching element 442 is turned off. Diode 446 may be a IDD03SG60C SiC Schottky diode from Infineon Technologies. Capacitor 450 may filter the high frequency noise generated by the capacitance of the windings of inductor 448. Capacitor 450 may be 22 nF. Inductor 448 stores energy to supply current to LEDs connected to output 304 while switching element 442 is switched off. Inductor 448 may be an inductor of about 100 turns of 24 gauge, triple-insulated wire wound around a Magnetics CO55118A2 toroid core.

Referring to FIG. 4B, power factor control circuit 314 may include resistors 432 and 436, which feed a signal representative of the current being supplied to LEDs connected to output 304. Based on this signal, SMPS controller 420 may adjust the timing of switching element 442, which modifies the current being supplied to output 304. Resistors 432 and 436 may be 1.5 kΩ and 1 MΩ, respectively.

Thermal protection circuit 312 includes transistor 434, thermistor 426, and resistor 424. Thermal protection circuit 312 also uses SMPS controller 420. In the exemplary embodiment, thermistor 428 is implemented as a positive temperature coefficient (PTC) thermistor. A PTC thermistor behaves as a normal low-value resistor at nominal operating temperatures (i.e., the resistance changes slowly as temperature changes). At low resistance values of thermistor 426, the gate of transistor 434 will stay low and transistor 434 will remain turned off. However, once the operating temperature passes a switching temperature, the resistance of the PTC thermistor 428 increases rapidly with increasing temperature. As the resistance of thermistor 428 rises, transistor 434 starts to turn on and pull down the voltage of LD pin 420h. This may cause a change in the timing of the signal on GATE pin 420d that results in less current being delivered to output 304. Transistor 434 may be a BSS 123 Power n-channel MOSFET from Weitron Technology. Resistor 424 is a pull-up resistor to ensure that the gate of transistor 434 does not float at high resistance values of thermistor 428. Resistor 424 may be 100 kΩ. Capacitor 430 is a filter that ensures transistor 434 does not cause the LED bulb to behave erratically by switching on and off too quickly. Capacitor 430 may be 4.7 uF.

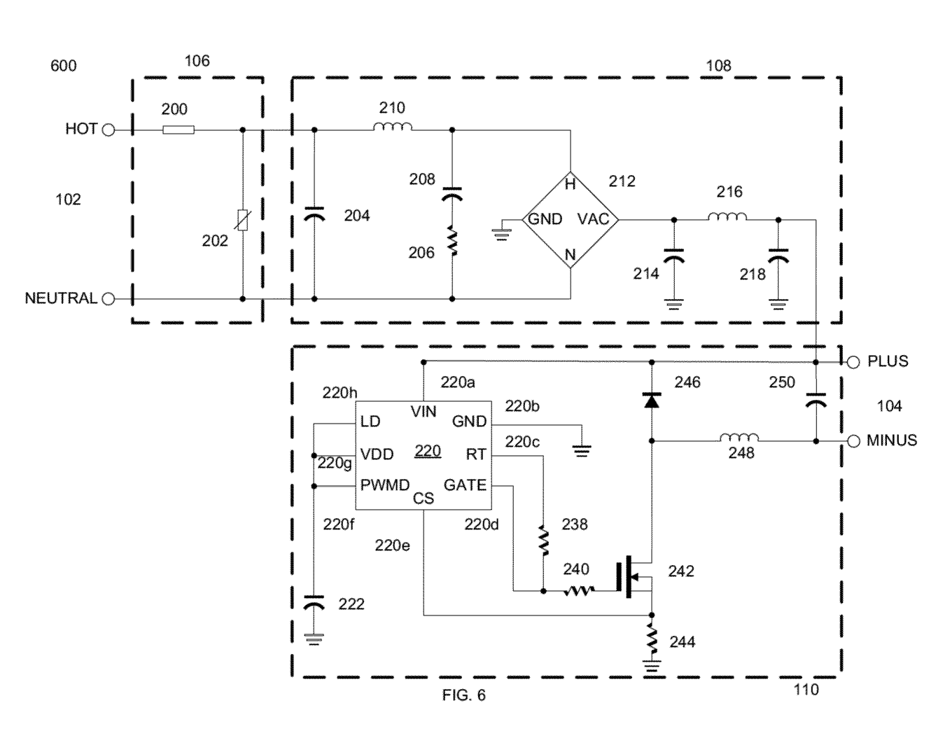

FIG. 6 depicts alternative exemplary driver circuit 600. Driver circuit 600 is similar to driver 300 (FIG. 3) except driver circuit 600 does not include temperature protection circuit 312 (FIG. 4B) or power factor control circuit 314 (FIG. 4B).

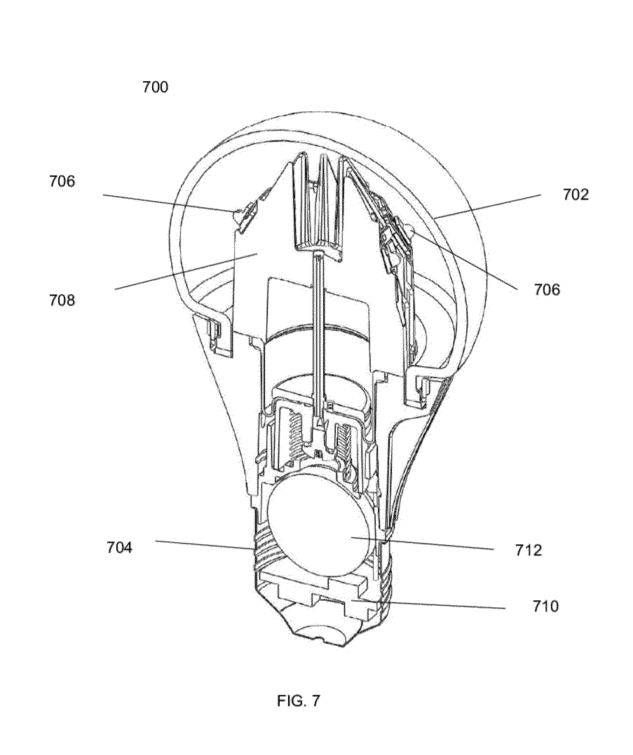

FIG. 7 depicts an exemplary LED bulb 700 with shell 702 and base 704. The LED bulb contains LEDs 706, heat sink 708, and driver circuit 710. In exemplary LED bulb 700, driver circuit 710 may be the driver circuit discussed above with respect to FIGS. 4A and 4B and is substantially contained within 704 base. In this context, substantially contained means that the majority of the driver circuit is within base 704 but portions of driver circuit components may be protruding from base 704. For example, the top part of inductor 712 may protrude above base 704 into heat sink 708 or shell 702 if the shell is connected directly to base 704. Additionally, substantially contained also means that one or more thermistors or other temperature-sensitive components may be located outside of base 704 if temperatures at locations other than driver circuit 710 are to be monitored. For example, one thermistor may be located on driver circuit 710 in base 704, while a second thermistor may be located on heat sink 708 or within shell 702. In these examples, driver circuit 710 is still substantially contained in base 704.

While base 704 is depicted as having threads for use in a screw-in socket, base 704 could also be configured to be compatible with other types of sockets. For example, an LED bulb according to the present invention could also have a bayonet mount for use with a bayonet-style socket.

### 4. Other Design Considerations for LED Drivers in LED Bulbs

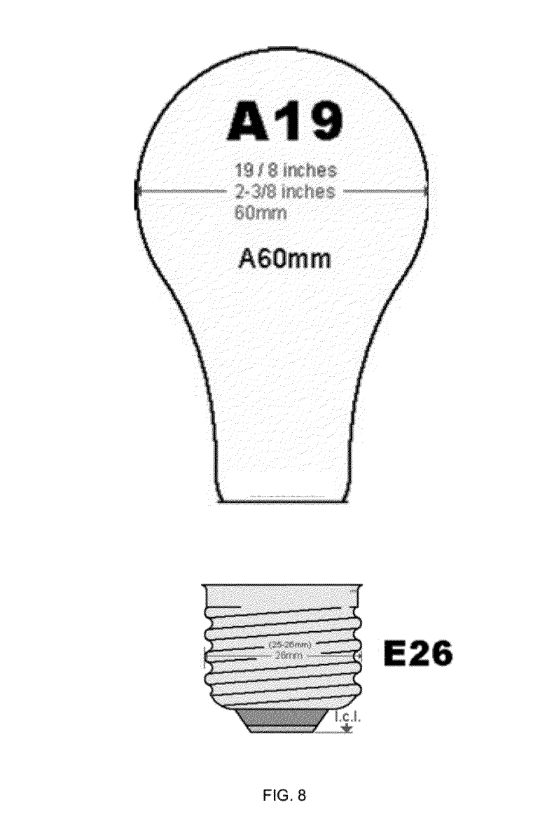

FIG. 8 depicts the A19 bulb and E26 base of a common lamp bulb form factor in the United States. LED bulbs must often fit all required components, including the driver circuit, heat sinks, and LEDs, within the A19 bulb and E26 connector. As such, the size and weight of the driver circuit is a significant design consideration because of the limited volume available in the A19 bulb and E26 connector enclosures. LED bulbs meant as replacements for common lamp bulbs in other countries are also limited to comparable volumes.

Additionally, another consideration in designing a driver circuit is the ability for the driver circuit to operate at fairly high temperatures, such as those generated in an LED bulb. This precludes the use of common electrolytic capacitors, which are likely to fail at high temperatures.

Furthermore, LED light illumination is a relatively high voltage application, limiting the types of capacitors available for a LED driver. These capacitors are generally small-value capacitors. The use of these small-value capacitors result in a driver circuit that has little or no energy storage from one line cycle to the next. For example, capacitors across the line may only be able to have a value of 0.1 uF. Therefore, an input inductor will have the full line switched voltage across it on each firing of the dimmer TRIAC. Moreover, large-value inductors are needed for sufficient filtering to provide attenuation at the switching frequency of the power supply (approximately 140 kHz). Because large-value inductors are generally also large in size, the selection of possible inductors for a driver circuit is limited by the size of the A19 bulb enclosure. Therefore, saturation of the inductors is likely. Inductor saturation is traditionally viewed as detrimental to a circuit. However, as described in the present disclosure, saturation of inductors can be utilized to beneficially shape the input current to minimize oscillations within the LED driver.

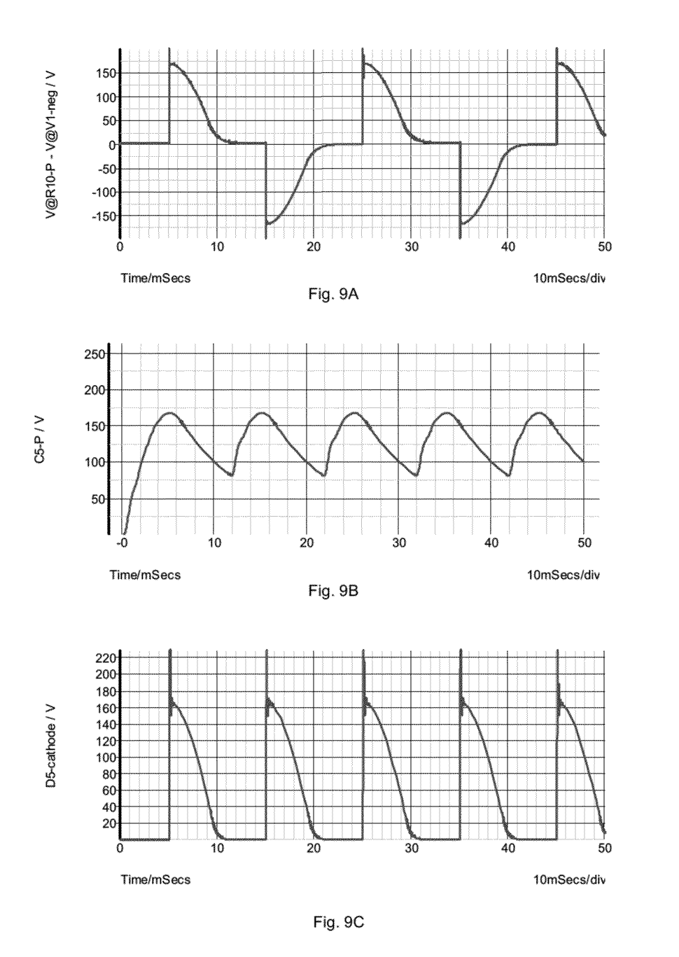

The small-value capacitors also result in a driver circuit that may dim the LEDs in proportion to the firing angle of a residential dimmer. For example, consider a voltage input coming from a residential dimmer that is dimmed to 50%. FIG. 9A depicts this voltage signal. In other driver circuit designs that store energy between input cycles, FIG. 9B depicts the voltage at the output of the input filter. Because the other driver circuit designs store significant amounts of energy, the output of the filter doesn't reach zero when the input voltage goes to zero at the start of each cycle.

In contrast, FIG. 9C depicts the output voltage from input filter 108 (FIG. 4B) in response to the voltage signal depicted in FIG. 9A being applied to input 102 (FIG. 4B) of the exemplary embodiment of driver circuit 100 described above. Because the driver circuit does not store significant amounts of energy in input filter 108, the output of input filter 108 returns to zero about the same time that the input voltage returns to zero. Again, the LED bulb will act more like a resistive load, which typically has a higher power factor because input filter 108 is configured to store approximately zero energy from one cycle of the AC voltage input to the next cycle.

The minimal energy storage of driver circuit 100 is based on the small sizes of the capacitors in input filter 108, especially capacitors 214 and 218. In other driver circuit designs with more energy storage, these capacitors may be up to tens of microfarads or more. Electrolytic capacitors may have to be used to reach these capacitances. However, electrolytic capacitors may have reliability concerns over the targeted long lifetime of LED bulbs and at the elevated operating temperatures typical of LED bulbs. Electrolytic capacitors may also be difficult to fit within an LED bulb. Therefore, the minimal energy storage of driver circuit 100 may also allow for use of ceramic capacitors, which may improve reliability and use less space.

Another potential benefit of the low energy storage is that an LED bulb using driver circuit 100 may not need any additional circuitry to dim the LEDs in response to a residential dimmer because the output of the input filter is already representative of the dimmer output. In contrast, LED bulbs using other driver circuit designs with more energy storage may need additional components to dim the LEDs because the output of the input filter is not representative of the input line voltage.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching.

We claim:

1. A light-emitting diode (LED) bulb for use with a leading-edge dimmer comprising:
a shell;
an LED contained within the shell;
a base attached to the bulb for connecting the LED bulb to an electrical socket;
a driver circuit for providing current to the LED, the driver circuit having an input filter circuit that comprises:
a first inductor, wherein, in response to the input filter receiving a switched AC voltage from a leading-edge dimmer set to dim at 50%, the first inductor is configured to saturate, and wherein, in response to an undimmed AC voltage from the leading-edge dimmer, the first inductor is configured to not saturate; and
a bridge rectifier connected to the first inductor.

2. The LED bulb of claim 1, wherein the input filter further comprises:
a second inductor connected to the bridge rectifier.

3. The LED bulb of claim 2, wherein, in response to an AC voltage from a leading-edge dimmer set to dim at 50%, the second inductor is configured to saturate, and wherein, in response to an undimmed AC voltage from the leading-edge dimmer, the second inductor is configured to not saturate

4. The LED bulb of claim 2, wherein the first and second inductors have the same design.

5. The LED bulb of claim 2, wherein the first inductor is connected to an input of the bridge rectifier and the second inductor is connected to an output of the bridge rectifier.

6. The LED bulb of claim 1, wherein the driver circuit is substantially contained within the base.

7. The LED bulb of claim 1, wherein, in response to an alternating current (AC) voltage input, the input filter circuit is configured to store approximately zero energy from one cycle of the AC voltage input to the next cycle.

8. A driver circuit for use with a leading-edge dimmer to provide current to an LED, the driver circuit comprising:
a first inductor, wherein, in response to the driver circuit receiving a switched AC voltage from a leading-edge dimmer set to dim at 50%, the first inductor is configured to saturate, and wherein, in response to an undimmed AC voltage from the leading-edge dimmer, the first inductor is configured to not saturate; and
a bridge rectifier connected to the first inductor.

9. The driver circuit of claim 8 further comprising:
a second inductor connected to the bridge rectifier.

10. The driver circuit of claim 9, wherein, in response to an AC voltage from a leading-edge dimmer set to dim at 50%, the second inductor is configured to saturate, and wherein, in response to an undimmed AC voltage from the leading-edge dimmer, the second inductor is configured to not saturate

11. The driver circuit of claim 9, wherein the first and second inductors have the same design.

12. The driver circuit of claim 9, wherein the first inductor is connected to an input of the bridge rectifier and second inductor is connected to an output of the bridge rectifier.

13. The driver circuit of claim 8, wherein, in response to an alternating current (AC) voltage input, the driver circuit is configured to store approximately zero energy from one cycle of the AC voltage input to the next cycle.
